(19) United States
(12) Patent Application Publication
(10) Pub. No.: US 2023/0356549 A1
(43) Pub. Date: Nov. 9, 2023

(54) SENSOR DEVICE

(71) Applicants: Taiwan Green Point Enterprises Co., Ltd., Taichung City (TW); Jabil Circuit (Singapore) Pte. Ltd., Singapore (SG)

(72) Inventors: Ching-Lung Mao, Taichung City (TW); Chin-Feng Yang, Taichung City (TW); Ming-Chung Chung, Taichung City (TW); Huang-Keng Chen, Taichung City (TW)

(73) Assignees: Taiwan Green Point Enterprises Co., Ltd., Taichung City (TW); Jabil Circuit (Singapore) Pte. Ltd., Singapore (SG)

(21) Appl. No.: 18/310,895

(22) Filed: May 2, 2023

(30) Foreign Application Priority Data
May 5, 2022 (TW) 111204605

(51) Int. Cl. B60C 23/04

(52) U.S. Cl. CPC B60C 23/0447; B60C 23/0493

(57) ABSTRACT

A sensor device includes a plurality of wires that are adapted to be disposed on an object, a control circuit that is electrically coupled to the wires, and a conductive member that is electrically coupled to the control circuit. Each of the wires has a detection section. The conductive member is operable to contact the detection sections of the wires. The detection sections are urged to move relative to the conductive member when the object is deformed, so that a quantity of the detection sections in contact with the conductive member varies with deformation of the object. When the conductive member is in contact with the detection section of any one of the wires, the conductive member and the one of the wires cooperatively form one closed circuit. The control circuit is adapted to transmit data of a quantity of the closed circuit to an external device.

### CROSS-REFERENCE TO RELATED APPLICATION

This application claims priority to Taiwanese Utility Model Patent Application No. 111204605, filed on May 5, 2022.

### FIELD

The disclosure relates to a sensor device, and more particularly to a sensor device that measures deformation of an object and air pressure in the object.

### BACKGROUND

Tire condition is an important factor in road safety. In general, whether a tire is in good condition depends on pressure of the tire and an extent of deformation of the tire. The pressure of the tire may be monitored by a sensor device, such as a tire-pressure monitoring device. However, a conventional tire-pressure monitoring device may have intricate mechanism and may be bulky, and the production process thereof may be very complicated. Thus, improvements in usage and production of the conventional tire-pressure monitoring device are necessary. Furthermore, the deformation of the tire has to be measured by a dedicated sensor, which makes real-time detection of the deformation of the tire difficult when the tire is in motion. Consequently, road safety may not be guaranteed.

### SUMMARY

Therefore, an object of the disclosure is to provide a sensor device that can alleviate at least one of the drawbacks of the prior art.

According to an aspect of the disclosure, the sensor device is adapted to be disposed on an object. The object is deformable in a first direction. The sensor device includes a plurality of wires and a state detecting unit. The wires are spaced apart from each other and are adapted to be disposed on the object. Each of the wires has a detection section. The detection sections of the wires are spaced apart from each other in the first direction. The state detecting unit is adapted to be disposed on the object, and includes a control circuit and a conductive member. The control circuit is electrically coupled to the wires. The conductive member is electrically coupled to the control circuit, is configured to be made of an electrically conductive material, and is operable to contact the detection sections of the wires. The detection sections are urged to move relative to the conductive member when the object is deformed, so that a quantity of the detection sections in contact with the conductive member varies with deformation of the object. When the conductive member is in contact with the detection section of any one of the wires, the conductive member and the one of the wires cooperatively form one closed circuit. The control circuit is adapted to transmit data of a quantity of the closed circuit to an external device.

According to another aspect of the disclosure, the sensor device includes a housing, a plurality of wires, and a state detecting unit. The housing has a deformation section that is deformable in a first direction when an external force is exerted on the deformation section in the first direction. The wires are disposed on an inner surface of the housing and are spaced apart from each other. Each of the wires has a detection section. The detection sections of the wires are disposed on the deformation section of the housing, and are spaced apart from each other in the first direction. The state detecting unit is disposed on the inner surface of the housing, and includes a control circuit and a conductive member. The control unit is electrically coupled to the wires. The conductive member is electrically coupled to the control circuit, is configured to be made of an electrically conductive material, and is operable to contact the detection sections of the wires. The detection sections are urged to move relative to the conductive member when the housing is deformed, so that a quantity of the detection sections in contact with the conductive member varies with deformation of the housing. When the conductive member is in contact with the detection section of any one of the wires, the conductive member and the one of the wires cooperatively form one closed circuit. The control circuit is adapted to transmit data of a quantity of the closed circuit to an external device.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view of a first embodiment of a sensor device according to the disclosure.

FIGS. 2 and 3 are schematic side views illustrating how the first embodiment functions.

FIG. 4 is a schematic perspective view of a second embodiment of the sensor device according to the disclosure.

FIGS. 5 and 6 are schematic side views illustrating how the second embodiment functions.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

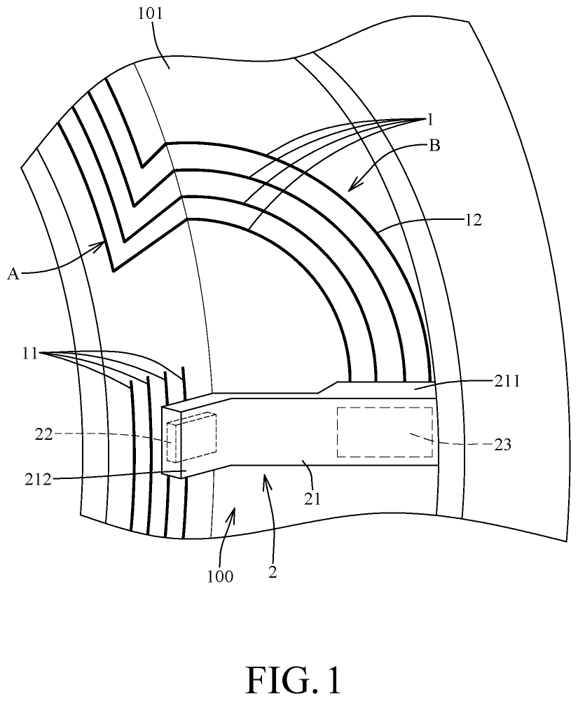

Referring to FIGS. 1 to 3, a first embodiment of a sensor device 100 according to the disclosure is adapted to be disposed on an object 101, and is for detecting an extent of deformation of the object 101. The object 101 may be configured as, for example, a tire 101. The sensor device 100 is capable of detecting the extent of the deformation of the tire 101 in real-time whether the tire 101 is in motion or not. It should be noted that in one embodiment, the object 101 may not be a tire. As long as the object 101 is deformable in a first direction when an external force is exerted thereon in the first direction, the sensor device 100 may be used for measuring the extent of the deformation of the object 101. In the first embodiment, the first direction is defined as a radial direction of the tire 101. The tire 101 is deformable in the radial direction thereof.

The first embodiment of the sensor device 100 includes a plurality of wires 1 and a state detecting unit 2. At least one of the state detecting unit 2 and the wires 1 is adapted to be disposed on the object 101 via a 3D printing process.

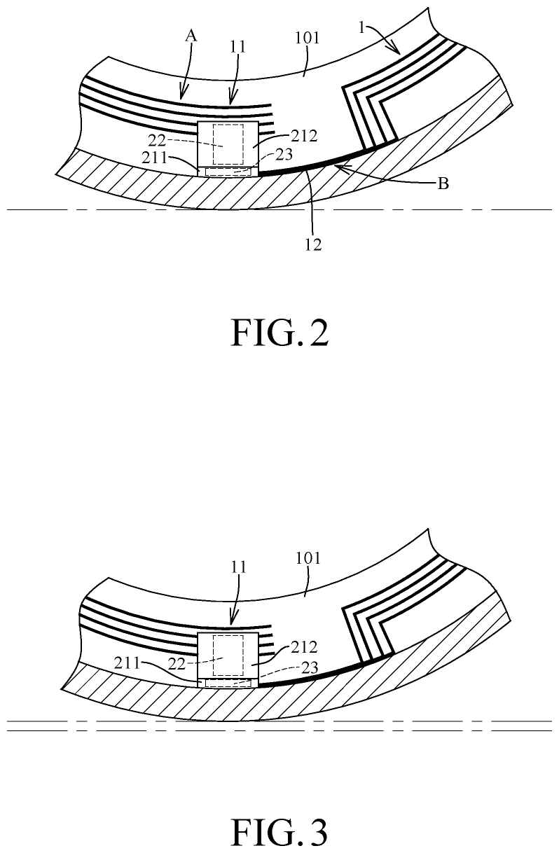

The wires 1 may be disposed on the object 101 via the 3D printing process, and are spaced apart from each other. Each of the wires 1 has a detection section 11 and an extension section 12. The detection sections 11 of the wires 1 are spaced apart from each other in the first direction. Referring to FIGS. 1 to 3 again, the first embodiment includes four wires 1 that are represented by bold lines. The wires 1 are disposed on an inner wall surface of the tire 101. Specifically, the detection sections 11 are located at an inner surface of a side wall of the tire 101 (i.e., an area labeled as A in FIGS. 1 and 2) so that the detection sections 11 are spaced apart from each other in the radial direction of the tire 101, and the extension sections 12 of the wires 1 are located at an inner surface of a tread of the tire 101 (i.e., an area labeled as B in FIGS. 1 and 2). The inner surface of the side wall of the tire 101 and the inner surface of the tread of the tire 101 cooperatively define the inner wall surface of the tire 101. Therefore, when the object 101 is deformed in the radial direction, a distance between any two of the detection sections 11 varies. When the state detecting unit 2 is in contact with any one of the wires 1, the state detecting unit 2 and the one of the wires 1 cooperatively form one closed circuit. It should be noted that arrangement of the wires 1, especially arrangement of the detection sections 11 described above is merely an example for the first embodiment, and may not be limited thereto. In one embodiment, the wires 1 may be disposed on the object 101 in a different manner as long as the detection sections 11 are spaced apart from each other in the first direction and each of the wires 1 is operable to cooperate with the state detecting unit 2 to form one closed circuit.

The state detecting unit 2 may be disposed on the object 101 via the 3D printing process. Specifically, the state detecting unit 2 is disposed on the inner surface of the tread of the tire 101 (i.e., the area labeled as B in FIGS. 1 and 2), and includes a main body 21, a control circuit 23, and a conductive member 22.

In the first embodiment, the main body 21 is configured to be elongated, and includes a mounting portion 211 that is fixedly mounted to the object 101 and that spans over the wires 1, and a detection portion 212 that is adjacent to the detection sections 11 and that is not fixedly connected to the object 101. The control circuit 23 is mounted to the mounting portion 211 and is electrically coupled to the extension sections 12 of the wires 1.

The conductive member 22 is configured to be made of an electrically conductive material, is electrically coupled to the control circuit 23, is mounted to one side of the detection portion 212 that faces the detection sections 11, is exposed from the detection portion 212, and is operable to contact the detection sections 11. When the object 101 is compressed and is temporarily or permanently deformed in the first direction, the detection sections 11 are urged to move relative to the conductive member 22 because the detection portion 212 to which the conductive member 22 is mounted is not fixedly connected to the detection sections 11 and the object 101, so that a quantity of the detection sections 11 in contact with the conductive member 22 varies with the deformation of the object 101. When the conductive member 22 is in contact with the detection section 11 of any one of the wires 1, the conductive member 22 and the one of the wires 1 cooperatively form one closed circuit. The control circuit 23 is capable of detecting whether the conductive member 22 is in contact with and conducted to any one of the wires 1, and is adapted to transmit data of a quantity of the closed circuit to an external device (not shown) via wireless transmission. When the external device receives the data transmitted by the control circuit, the external device may determine the extent of the deformation of the object 101 according to the quantity of the closed circuit so that the deformation of the object 101 (e.g., a tire) may be measured in real-time.

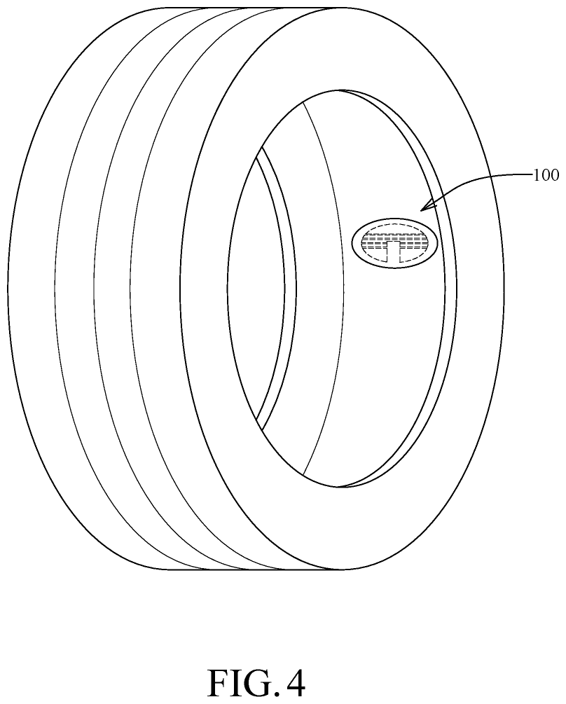

In the first embodiment, a correlation between the quantity of the detection sections 11 in contact with the conductive member 22 and the extent of the deformation of the object 101 is positive. The conductive member 22 is capable of contacting all of the detection sections 11 at a time. Referring to FIGS. 1 and 2 again, the conductive member 22 is only in contact with the detection sections 11 of two of the wires 1 that are closer to the tread of the tire 101. Therefore, the control circuit 23 detects that there are two closed circuits, and transmits the data to the external device accordingly. The external device may thus determine, according to the data, that there is no deformation of the object 101, or that the extent of the deformation is relatively slight at this time. In contrast, referring to FIG. 3, the object 101 is deformed to a certain extent in the first direction (i.e., the radial direction of the tire 101) and the detection sections 11 are urged to move relative to the conductive member 22 such that the conductive member 22 is in contact with three of the detection sections 11 that are close to the tread of the tire 101. Consequently, the control circuit 23 detects that there are three closed circuits. Afterwards, the external device receives the data from the control circuit 23 and then determines that the extent of the deformation of the object 101 shown in FIG. 3 is greater than that of the object 101 shown in FIGS. 1 and 2, and may send a notification to a user that the user should beware of the deformation of the tire.

In summary, in the first embodiment, by virtue of the wires 1 and the state detecting unit 2, the sensor device 100 is capable of measuring the extent of the deformation of the object 101 in real-time. Moreover, because the configurations of the wires 1 and the state detecting unit 2 are relatively simple and may be printed via the 3D printing process, the sensor device 100 may be applicable to various objects that are deformable, and may measure the extent of deformation of each of them.

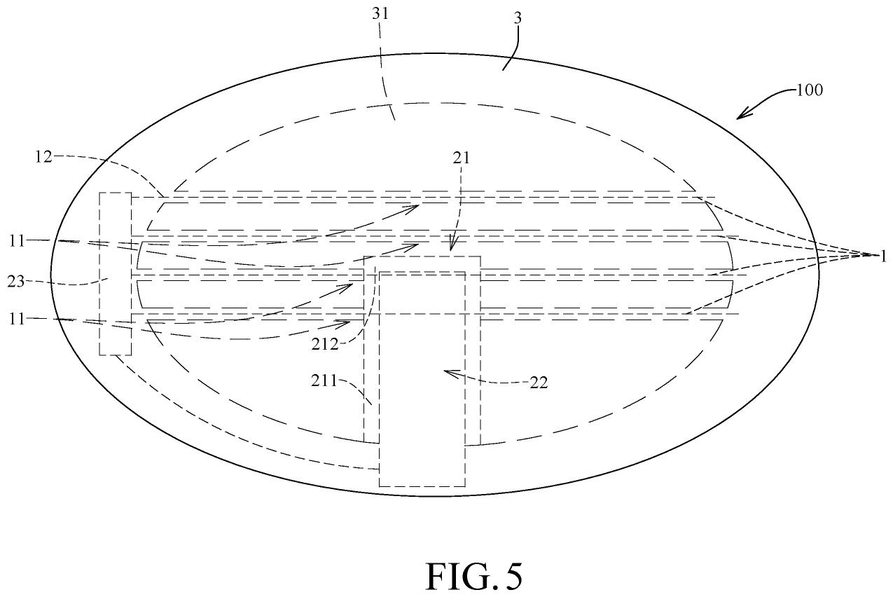

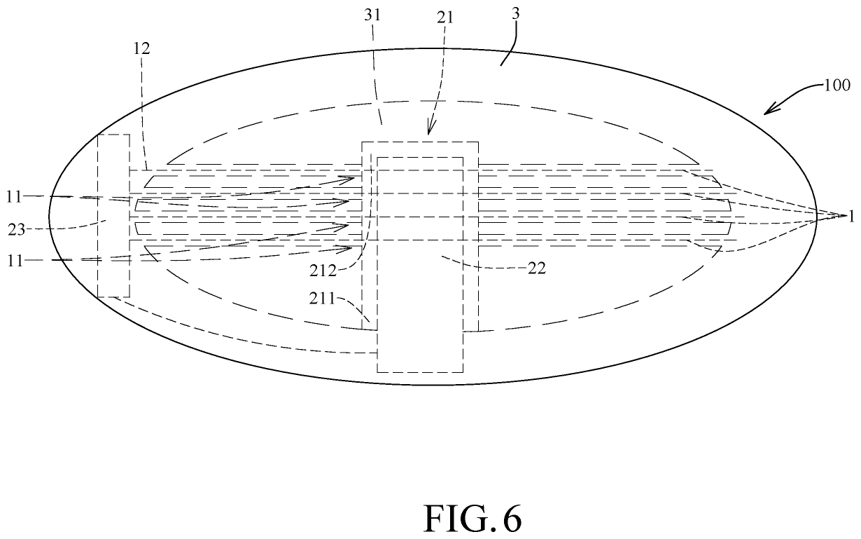

Referring to FIGS. 4 to 6, a second embodiment of the sensor device 100 according to the disclosure is similar to the first embodiment, but further includes a housing 3. In addition, the second embodiment may, but not limited to, be disposed on an inner wall surface of a tubeless tire (see FIG. 4). After the tubeless tire and a wheel frame (not shown) are assembled, the tubeless tire and the wheel frame cooperatively define a space therebetween. The sensor device 100 may monitor tire pressure by measuring air pressure in the space in real-time. It should be noted that, in FIGS. 5 and 6, an interior of the housing 3 is represented by long-dashed broken lines, and the wires 1 and the state detecting unit 2 are represented by short-dashed broken lines.

In the second embodiment, the housing 3 may have, for example, a hollow structure without openings, and has at least one deformation section 31 that is deformable in the first direction when an external force is exerted on the deformation section 31 in the first direction. The housing 3 may be configured to, but not limited to, be made of a resilient material, such as rubber, so that the housing 3 is resiliently deformable (i.e., the housing 3 will be restored to its original shape when the housing 3 is free from the external force). Furthermore, referring to FIGS. 5 and 6 again, the housing 3 has an elliptical cross section, and the elliptical cross section has a minor axis that extends in the first direction. By virtue of the housing 3 having the elliptical cross section, when the housing 3 is compressed under a force caused by a change in the air pressure in the space between the tubeless tire and the wheel frame, the deformation section 31 may be relatively easy to deform in an extending direction of the minor axis (i.e., the first direction). It should be noted that, in one embodiment, the housing 3 may not have the hollow structure, and may be a component-carrying cover member that carries the wires 1 and the state detecting unit 2, and that cooperates with the inner wall surface of the tubeless tire to form a hollow structure.

In the second embodiment, at least one of the state detecting unit 2 and the wires 1 is disposed on the housing 3 via the 3D printing process. The wires 1 are disposed on an inner surface of the housing 3 via, for example, the 3D printing process, and are spaced apart from each other. Each of the wires 1 has the detection section 11 and the extension section 12. The detection sections 11 of the wires 1 are disposed on the deformation section 31 of the housing 3, and are spaced apart from each other in the first direction (i.e., the extending direction of the minor axis). Exemplarily, the second embodiment includes four wires 1 (see FIGS. 5 and 6). The detection sections 11 are disposed on an inner lateral surface of one lateral side of the housing 3 (i.e., one portion of the inner surface of the housing 3). The extension sections 12 of the wires 1 may be disposed on another portion of the inner surface of the housing 3, or embedded into the housing 3.

The state detecting unit 2 is disposed on the inner surface of the housing 3 via, for example, the 3D printing process, and is similar to the state detecting unit 2 in the first embodiment. In the second embodiment, the main body 21 of the state detecting unit 2 includes the mounting portion 211 that is fixedly mounted to the inner surface of the housing 3, and the detection portion 212 that is adjacent to the detection sections 11 and that is not fixedly connected to the housing 3. Exemplarily, the main body 21 is located at the minor axis of the elliptical cross section of the housing 3. The detection portion 212 extends in the first direction, and the mounting portion 211 interconnects the detection portion 212 and a middle part of the elliptical cross section of the housing 3. The control circuit 23 is electrically coupled to the extension sections 12 of the wires 1, is capable of detecting whether the conductive member 22 is in contact with and conducted to any one of the wires 1, and is adapted to transmit the data of the quantity of the closed circuit to the external device (not shown) via wireless transmission. The conductive member 22 is configured to be made of an electrically conductive material, is electrically coupled to the control circuit 23, is mounted to one side of the detection portion 212 that faces the detection sections 11, is exposed from the detection portion 212, and is operable to contact the detection sections 11.

In the second embodiment, the detection sections 11 are urged to move relative to the conductive member 22 when the housing 3 is deformed by a change in external air pressure, so that the quantity of the detection sections 11 in contact with the conductive member 22 varies with deformation of the housing 3. When the conductive member 22 is in contact with the detection section 11 of any one of the wires 1, the conductive member 22 and the one of the wires 1 cooperatively form one closed circuit. The control circuit 23 is capable of detecting whether the conductive member 22 is in contact with and conducted to any one of the wires 1, and is adapted to transmit the data of the quantity of the closed circuit to the external device (not shown) via wireless transmission. A correlation between the quantity of the detection sections 11 in contact with the conductive member 22 and the extent of the deformation of the housing 3 is positive. For example, as shown in FIG. 5, when there is no significant deformation of the housing 3 (i.e., there is no excessive air pressure in the space between the tubeless tire and the wheel frame), the conductive member 22 is only in contact with two of the wires 1 such that there are two closed circuits. In contrast, referring to FIG. 6, when the air pressure increases, the housing 3 is deformed in the first direction (the extending direction of the minor axis) to a certain extent. At this time, the conductive member 22 is in contact with all of the wires 1 (i.e., four wires 1). The control circuit 23 detects that there are four closed circuits. Afterwards, the external device receives the data from the control circuit 23 and then determines that the housing 3 may have significantly deformed under a greater air pressure compared with the situation in FIG. 5. The external device may thus send a notification to the user that the user should beware of the tire pressure. When the quantity of the wires 1 in contact with the conductive member 22 is smaller than the situation in FIG. 5 (i.e., when the conductive member 22 is in contact with only one of the wires 1), the control circuit 23 detects that there is only one closed circuit. At this time, after receiving the data from the control circuit 23, the external device may determine that the tire pressure, compared with the situation in FIG. 5, is smaller. Similarly, the external device may send a notification to the user that the user should beware of the tire pressure, thereby ensuring road safety.

In summary, by virtue of the wires 1 and the state detecting unit 2, the sensor device 100 may have a relatively simple configuration with a reduced size, and may measure the extent of deformation of the tire and tire pressure, which are deciding factors that influence the tire, in real-time for ensuring road safety, and the production of the sensor device 100 is also simplified. Moreover, the scope of applications of the sensor device 100 may not be limited to tires. The sensor device 100 may be used for any object, as long as the object is deformable or is provided with space, as the aforesaid space, in which the housing 3 may be disposed. Thus, the purpose of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A sensor device adapted to be disposed on an object, the object being deformable in a first direction, the sensor device comprising:
a plurality of wires spaced apart from each other and adapted to be disposed on the object, each of the wires having a detection section, the detection sections of the wires being spaced apart from each other in the first direction; and
a state detecting unit adapted to be disposed on the object, and including a control circuit that is electrically coupled to the wires, and a conductive member that is electrically coupled to the control circuit, that is configured to be made of an electrically conductive material, and that is operable to contact the detection sections of the wires, the detection sections being urged to move relative to the conductive member when the object is deformed, so that a quantity of the detection sections in contact with the conductive member varies with deformation of the object, when the conductive member is in contact with the detection section of any one of the wires, the conductive member and the one of the wires cooperatively forming one closed circuit, the control circuit being adapted to transmit data of a quantity of the closed circuit to an external device.

2. The sensor device as claimed in claim 1, wherein a correlation between the quantity of the detection sections in contact with the conductive member and an extent of the deformation of the object is positive, the conductive member being capable of contacting all of the detection sections at a time.

3. The sensor device as claimed in claim 1, wherein each of the wires further includes an extension section, the state detecting unit further including a main body that includes a mounting portion fixedly mounted to the object, the control circuit being mounted to the mounting portion and being electrically coupled to the extension sections of the wires.

4. The sensor device as claimed in claim 1, wherein the state detecting unit further includes a main body that includes a detection portion adjacent to the detection sections of the wires, the conductive member being mounted to one side of the detection portion that faces the detection sections.

5. The sensor device as claimed in claim 4, wherein the conductive member is exposed from the detection portion.

6. The sensor device as claimed in claim 1, wherein the control circuit is adapted to transmit the data of the quantity of the closed circuit to the external device via wireless transmission.

7. The sensor device as claimed in claim 1, the object being configured as a tire, the tire being deformable in a radial direction thereof, wherein the wires and the state detecting unit are disposed on an inner wall surface of the tire, the detection sections being spaced apart from each other in the radial direction of the tire.

8. The sensor device as claimed in claim 1, wherein at least one of the state detecting unit and the wires is adapted to be disposed on the object via a 3D printing process.

9. A sensor device, comprising:
a housing having a deformation section that is deformable in a first direction when an external force is exerted on the deformation section in the first direction;
a plurality of wires disposed on an inner surface of the housing and spaced apart from each other, each of the wires having a detection section, the detection sections of the wires being disposed on the deformation section of the housing and being spaced apart from each other in the first direction; and
a state detecting unit disposed on the inner surface of the housing, and including a control circuit that is electrically coupled to the wires, and a conductive member that is electrically coupled to the control circuit, that is configured to be made of an electrically conductive material, and that is operable to contact the detection sections of the wires, the detection sections being urged to move relative to the conductive member when the housing is deformed, so that a quantity of the detection sections in contact with the conductive member varies with deformation of the housing, when the conductive member is in contact with the detection section of any one of the wires, the conductive member and the one of the wires cooperatively forming one closed circuit, the control circuit being adapted to transmit data of a quantity of the closed circuit to an external device.

10. The sensor device as claimed in claim 9, wherein the housing has an elliptical cross section, and the elliptical cross section has a minor axis that extends in the first direction, the detection sections of the wires being spaced apart from each other in an extending direction of the minor axis.

11. The sensor device as claimed in claim 9, wherein the housing is configured to be made of a resilient material so that the housing is resiliently deformable.

12. The sensor device as claimed in claim 9, wherein a correlation between the quantity of the detection sections in contact with the conductive member and an extent of the deformation of the housing is positive, the conductive member being capable of contacting all of the detection sections at a time.

13. The sensor device as claimed in claim 9, wherein each of the wires further includes an extension section, the state detecting unit further including a main body that includes a mounting portion fixedly mounted to the housing, the control circuit being electrically coupled to the extension sections of the wires.

14. The sensor device as claimed in claim 9, wherein the state detecting unit further includes a main body that includes a detection portion adjacent to the detection sections of the wires, the conductive member being mounted to one side of the detection portion that faces the detection sections.

15. The sensor device as claimed in claim 14, wherein the conductive member is exposed from the detection portion.

16. The sensor device as claimed in claim 9, wherein the control circuit is adapted to transmit the data of the quantity of the closed circuit to the external device via wireless transmission.

17. The sensor device as claimed in claim 9, wherein at least one of the state detecting unit and the wires is disposed on the housing via a 3D printing process.

18. The sensor device as claimed in claim 9, wherein the housing has a hollow structure.

19. The sensor device as claimed in claim 9, wherein the housing is configured to be a component-carrying cover member that carries the wires and the state detecting unit.

20. The sensor device as claimed in claim 9, wherein the housing has an elliptical cross section that has a minor axis extending in the first direction, the state detecting unit further including a main body that includes a detection portion and a mounting portion, and that is located at the minor axis of the elliptical cross section of the housing, the detection portion extending in the first direction, the mounting portion interconnecting the detection portion and a middle part of the elliptical cross section of the housing.
